(19) United States
(12) Patent Application Publication
(10) Pub. No.: US 2019/0373879 A1
(43) Pub. Date: Dec. 12, 2019

(54) APPARATUS, SYSTEM, AND METHOD FOR MAINTAINING FISHING EQUIPMENT

(71) Applicants: Austin VanAusdal, Santa Clara, UT (US); Richard VanAusdal, Santa Clara, UT (US)

(72) Inventors: Austin VanAusdal, Santa Clara, UT (US); Richard VanAusdal, Santa Clara, UT (US)

(21) Appl. No.: 16/002,369

(22) Filed: Jun. 7, 2018

(51) Int. Cl. A01K 97/06; B65D 53/00; B65D 85/50

(52) U.S. Cl. CPC A01K 97/06; B65D 85/50; B65D 53/00

(57) ABSTRACT

An apparatus for protecting and maintaining a fish attraction device, including fishing flies, lures or bait. The apparatus includes a shell that surrounds the attraction device. The shell may be formed of multiple parts, each part creating a portion the shell. The apparatus may further include a gasket configured to surround the fishing line, the gasket creating a watertight seal between the fishing line and the shell such that the shell maintains a freshness of the object attached to the fishing line

### FIELD OF THE INVENTION

The present invention relates generally to devices for maintaining fishing equipment. In particular, it relates to a device having a shell that surrounds a fishing lure or fishing bait with a watertight seal for maintaining the lure or bait in an appropriate environment.

### BRIEF DESCRIPTION OF THE DRAWINGS

Advantages of the invention will become apparent upon reading the following detailed description and upon reference to the drawings.

FIG. 1 is a front view illustrating one embodiment of an apparatus for maintaining fishing equipment in accordance with the present subject matter;

FIG. 2 is a rear view further illustrating the apparatus for maintaining fishing equipment of FIG. 1 in accordance with the present subject matter;

FIG. 3 is a front view further illustrating the apparatus for maintaining fishing equipment of FIG. 1 with the shell positioned in an open position in accordance with the present subject matter;

FIG. 4 is a side view further illustrating one embodiment the apparatus for maintaining fishing equipment of FIG. 1 in accordance with the present subject matter;

FIG. 5 depicts a side view illustrating one embodiment of an apparatus for maintaining fishing equipment with the apparatus coupled to a fishing pole with a coupling member; and

FIG. 6 is a front view illustrating one embodiment of an apparatus for maintaining fishing equipment that includes a hooking element in accordance with the present subject matter.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, forward and rearward, and the like may be used solely to distinguish one entity or action from another entity or action without necessarily requiring or implying any actual such relationship, direction or order between such entities or actions.

Furthermore, the described features, structures, or characteristics of the subject matter may be combined in any suitable manner in one or more embodiments. In the following description, numerous specific details are provided for a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Embodiments of the present invention relate to a device used to protect and maintain fishing equipment, and in particular to protect and maintain the attraction devices used to attract and hook fish, such as fishing flies, lures, artificial and natural bait and other such devices and materials. Throughout the following description, reference will be made to a fishing fly by way of example. However, it should be understood that the present invention is applicable for use with any of the noted or other attraction devices. It should be further understood that the term “fishing fly” as used in the following description and claims refers to any of these attraction devices unless the express language or context makes clear that the attraction device is limited to some subset of such devices.

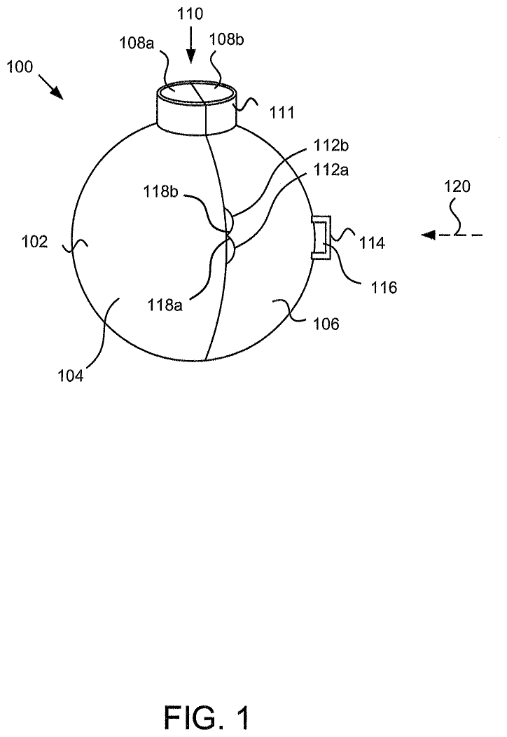

FIG. 1 is a front view illustrating one embodiment of an apparatus 100 for maintaining fishing equipment in accordance with the present subject matter. In certain embodiments, the apparatus 100 includes a shell 102 and a gasket 108.

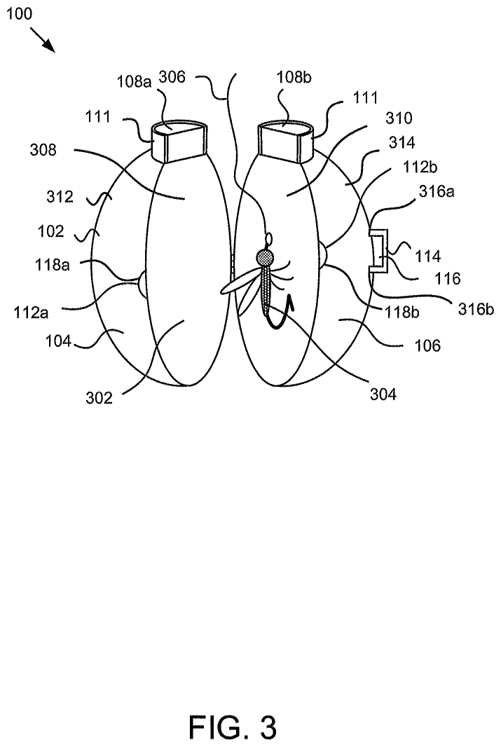

In one embodiment, the shell 102 is configured to receive an object attached to a fishing line 306 (see FIG. 3). For example, in an exemplary embodiment, the shell 102 is watertight and defines an object receiving space 302 (see FIG. 3) for receiving a fishing fly 304 (see FIG. 3). In such an embodiment, the shell 102 may include two pieces, a first partial enclosure 104 and a second partial enclosure 106.

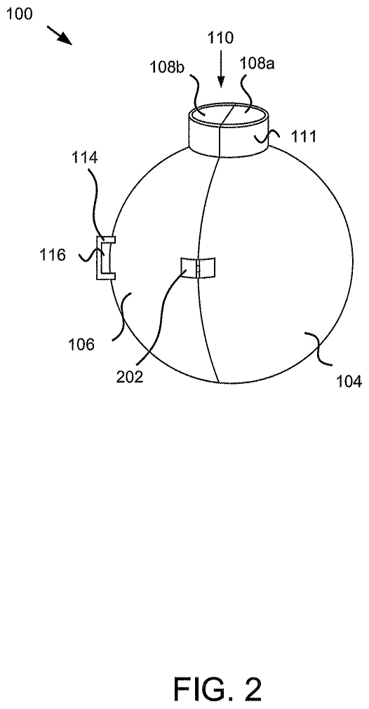

In certain embodiments, the first partial enclosure 104 and the second partial enclosure 106 are coupled to one another by a hinge 202 (see FIG. 2). In other embodiments, the first partial enclosure 104 and the second partial enclosure 106 may be separate elements that are coupleable with one another by a snap fit or similar arrangement. In either embodiment, the first partial enclosure 104 is matingly receivable with the second partial enclosure 106 to form the shell 102 when the first partial enclosure 104 and the second partial enclosure 106 are positioned in a closed position as shown in FIG. 1. While the embodiments illustrated in the figures show the shell 102 as being spherical, in other embodiments, the shell 102 may be any other geometric shape.

The shell 102, in certain embodiments, includes an opening 110 at one end of the shell 102. In such an embodiment, the gasket 108 is positioned within the opening 110 to keep water from entering the object receiving space 302. The gasket 108, in certain embodiments, is a two part gasket having a first semicircular part 108a and a second semicircular part 108b. As used herein, the first semicircular part 108a and the second semicircular part 108b are collectively referred to as gasket 108. When the two parts 108a and 108b are positioned together, they completely fill the opening 110 to keep water from entering the object receiving 302. In this position, the gasket 108 still allows a fishing line 306 to extend from within the object receiving 302. While the opening 110 is depicted in the Figures as being circular, one of skill in the art will recognize that the opening may have any geometric shape. Similarly, one of skill in the art will recognize that the gasket 108 may have any geometric shape corresponding to the geometric shape of the opening 110.

In one embodiment, the apparatus 100 includes a neck 111 at one end of the shell 102. In such an embodiment, the opening 110 is positioned in the neck 111. The gasket 108 is received within the opening 110 in the neck 111 to seal the opening 110 and create a watertight environment for an object (i.e., the fishing fly 304, fishing lure, or other bait) received within the shell 102.

The gasket 108, in one embodiment, keeps water from infiltrating the object receiving space 302 when the first partial enclosure 104 and the second partial enclosure 106 are positioned in the closed position. In other embodiments, it may be desirable to keep the fishing fly 304, fishing lure, or other bait wet. In such an embodiment, the object receiving space 302 may be filled with water (or another liquid) and the shell 102 and the gasket 108 may operate to keep the liquid within the object receiving space 302. In either embodiment, the gasket 108 is configured to surround the fishing line 396 to create a watertight seal between the fishing line 306 and the shell 102. In this manner, the shell 102 and the gasket 108 maintain a freshness of the object (i.e., the fishing fly 304, fishing lure, or other bait) attached to the fishing line 306.

In certain embodiments, a first closing flange 112a extends from the first partial enclosure 104 of the shell 102. Similarly, a second closing flange 112b extends from the second partial enclosure 106 of the shell 102. The first and second closing flanges 112a and 112b engage one another to keep the shell 102 in the closed position as depicted in FIG. 1. Additionally, in one embodiment, the first and second closing flanges 112a and 112b may provide extensions engageable by a users fingers to assist a user in opening and closing the apparatus 100.

In an exemplary embodiment, an edge 118a of the first closing flange 112a is engageable with an edge 118b of the second closing flange 112b. In such an embodiment, when the edge 118a of the first closing flange 112a is engaged with the edge 118b of the second closing flange 112b, the first and second closing flanges 112a and 112b respectively resist disengagement and therefore restrict the opening of the apparatus 100.

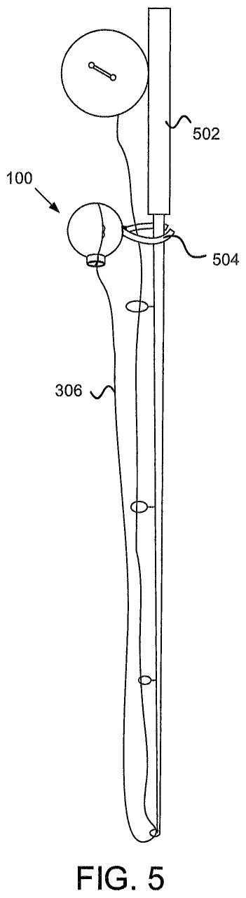

In one embodiment, a bridging element 114 is attached to one of the first partial enclosure 104 and the second partial enclosure 106 of the shell 102. The bridging element 114 facilitates coupling the shell 102 to a fishing pole 502 (see FIG. 5) as discussed below. The bridging element 114 is attached to one of the first partial enclosure 104 and the second partial enclosure 106 of the shell 102 at two positions to define a coupling element receiving slot 116 for receiving a coupling element 504 (see FIG. 5) that attaches the shell 102 to the fishing pole 502.

FIG. 2 is a rear view further illustrating the apparatus 100 of FIG. 1 in accordance with the present subject matter. In certain embodiments, the apparatus 100 includes a hinge 202 that couples the first partial enclosure 104 of the shell 102 to the second partial enclosure 106 of the shell 102.

In one embodiment, the first partial enclosure 104 of the shell 102 and the second partial enclosure 106 of the shell 102 are pivotable about the hinge 202 to reposition the first partial enclosure 104 of the shell 102 and the second partial enclosure 106 of the shell 102 from an opened positioned (see FIG. 1) to a closed position (see FIG. 3). When the first partial enclosure 104 of the shell 102 and the second partial enclosure 106 of the shell 102 are positioned in the closed position the shell 102 is watertight. When the first partial enclosure 104 of the shell 102 and the second partial enclosure 106 of the shell 102 are positioned in the opened position, the object receiving space 302 is accessible for receiving an object (i.e., the fishing fly 304, fishing lure, or other bait) attached to a fishing line 306.

FIG. 3 is a front view illustrating one embodiment of an apparatus 100 for maintaining fishing equipment with the shell 102 positioned in an open position in accordance with the present subject matter. As discussed above, in certain embodiments, the shell 102 includes a first partial enclosure 104 disposed opposite a second partial enclosure 106. The first partial enclosure 104 of the shell 102 is matingly receivable with the second partial enclosure 106 of the shell 102 to define an object receiving space 302 within the shell 102.

In one embodiment, upon mating the first partial enclosure 104 of the shell 102 with the second partial enclosure 106 of the shell 102, the shell 102 becomes a watertight shell. Thus, once the first partial enclosure 104 of the shell 102 is coupled with the second partial enclosure 106 of the shell 102, water cannot enter or leave the object receiving space 302. In this manner, the fishing fly 302 or other bait may be kept wet or dry according to the users desires.

In other embodiments, the shell 102 may simply protect the fishing fly 302 or other bait from physical damage during transport of the equipment without keeping the fishing fly 302 wet or dry. That is, in one embodiment, the object receiving space 302 may not be watertight. In such embodiments, the shell protects the object in the object receiving space 302 from damage from external contact.

In an exemplary embodiment, the first partial enclosure 104 of the shell 102 includes a first substantially hemispheric surface 308 defining approximately one half a spherical void. Similarly, the second partial enclosure 106 of the shell 102 includes a second substantially hemispheric surface 310 defining approximately one half a spherical void. The first substantially hemispheric surface 308 of the first partial enclosure 104 and the second substantially hemispheric surface 310 of the second partial enclosure 106 define the object receiving space 302. When the first partial enclosure 104 of the shell 102 is mated with the second partial enclosure 106 of the shell 102, the object receiving space 302 is substantially spherical.

As discussed above, in certain embodiments, the gasket 108 includes a first semicircular part 108a and a second semicircular part 108b. The first semicircular part 108a is positioned within the portion of the neck 111 extending from the first partial enclosure 104 of the shell 102. The second semicircular part 108b is positioned within the portion of the neck 111 extending from the second partial enclosure 106 of the shell 102. When the first partial enclosure 104 of the shell 102 and the second partial enclosure 106 of the shell 102 are positioned in the closed position (see FIG. 1), the gasket 108 forms a seal between the neck 111 and the fishing line 306.

In one embodiment, the first partial enclosure 104 of the shell 102 includes an outer surface 312 disposed opposite the inner surface 308. Similarly, the second partial enclosure 106 of the shell 102 includes an outer surface 314 disposed opposite the inner surface 310. The inner surfaces 308 and 310 define the object receiving space 302 within the shell 102.

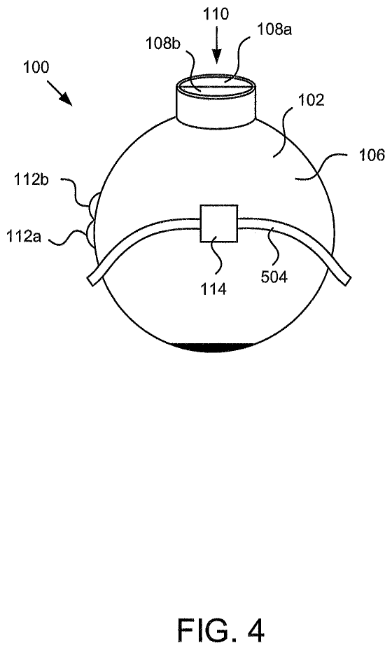

In certain embodiments, at least one of the outer surfaces 312, 314 of the shell 102 includes a bridging element 114 extending from the outer surface 312 or 314 of the shell 102. In such an embodiment, the bridging element 114 defines a coupling element receiving slot 116. The bridging element 114 facilitates coupling the shell 102 to a fishing pole 502 (see FIG. 5). The bridging element 114 is attached to either the first partial enclosure 104 or the second partial enclosure 106 of the shell 102 at two positions (i.e., positions 316a and 316b) to define a coupling element receiving slot 116 for receiving a coupling element 504 (see FIG. 4) that attaches the shell 102 to the fishing pole 502.

FIG. 4 is a side view illustrating one embodiment the apparatus 100 for maintaining fishing equipment looking in the direction of arrow 120 of FIG. 1 in accordance with the present subject matter. In the embodiment illustrated in FIG. 4, the coupling element 504 has been positioned within the coupling element receiving slot 116 defined by the bridging element 114.

In one embodiment, the coupling element 504 may be a simple twist tie as commonly found on a bread bag. The twist tie may be twisted around the fishing pole 502 to couple the shell 102 to the fishing pole 502. In other embodiments, the coupling element 504 may be a piece of fabric having a hook and loop closure system. In yet another embodiment, the coupling element 504 may be a piece of string or other chord. One of skill in the art will recognize other coupling elements that may be used to couple the shell 102 of the apparatus 100 to the fishing pole 502.

FIG. 5 depicts a side view illustrating one embodiment of an apparatus 100 for maintaining fishing equipment. In FIG. 5, the apparatus 100 is depicted as being coupled to a fishing pole 502 with the coupling member 504. In use, the first partial enclosure 104 of the shell 102 and the second partial enclosure 106 of the shell 102 are positioned on either side of an object (i.e., the fishing fly 304, fishing lure, or other bait) fastened to the end of the fishing line 306. The first partial enclosure 104 of the shell 102 and the second partial enclosure 106 of the shell 102 are positioned in the closed position (see FIG. 1) to create a watertight shell surrounding the object. The gasket 108 surrounds the fishing line 306 to keep water from infiltrating the object receiving space 302 within the shell 102.

In one embodiment, before sealing shell 102 by closing the first partial enclosure 104 of the shell 102 and the second partial enclosure 106 of the shell 102, water may be placed within the object receiving space 302 in the shell 102. In other embodiments, the user may wish to keep water out of the object receiving space 302 within the shell 102. In such an embodiment, the shell 102 may be positioned in the closed position without filling the object receiving space 302 within the shell 102 with water.

With the object (i.e., the fishing fly 304, fishing lure, or other bait) positioned within the object receiving space 302 within the shell 102, the apparatus 100 is ready to be coupled to the fishing pole 502. The coupling element 504 may be used to couple the apparatus 100 to the fishing pole 502. As discussed above, the coupling element 504 may be a twist-tie, a hook and loop closure system, a length of cord, or any other device configured to couple an apparatus to a fishing pole 502.

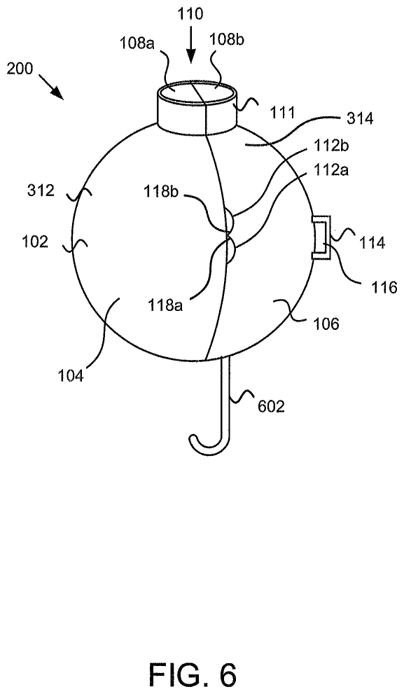

FIG. 6 is a front view illustrating one embodiment of an apparatus 200 for maintaining fishing equipment that includes a hooking element 602 in accordance with the present subject matter. The apparatus 200, in certain embodiments, is substantially similar to the apparatus 100 discussed above. Thus, in one embodiment, the apparatus 200 includes a shell 102 and a gasket 108.

The apparatus 200 differs from the apparatus 100 discussed above in that the apparatus 200 includes a hooking element 602. In such an embodiment, the first partial enclosure 104 of the shell 102 includes an outer surface 312 disposed opposite the inner surface 308 (see FIG. 3). Similarly, the second partial enclosure 106 of the shell 102 includes an outer surface 314 disposed opposite the inner surface 310 (see FIG. 3). The inner surfaces 308 and 310 define the object receiving space 302 (see FIG. 3) within the shell 102.

In certain embodiments, at least one of the outer surfaces 312, 314 of the shell 102 includes a hooking element 602 extending front the outer surface 312 or 314 of the shell 102. In such an embodiment, the hooking element 602 is configured to hook the apparatus 200 to a fishing pole 502.

The apparatus 100 and 200 provides several benefits over the prior art including the ability to keep the fishing fly 304 or other bait dry or wet as desired by the user, the ability to couple the fishing fly 304 or other bait to the fishing pole 502 without damage to the fishing pole 502, and the ability to protect the user from accidentally poking themselves with the fishing fly 304 or hook in other bait.

While the present invention has been described with reference to one or more particular embodiments, those skilled in the art will recognize that many changes may be made thereto without departing from the spirit and scope of the present invention. Furthermore, components from one embodiment can be used in other non-exclusive embodiments. Each of these embodiments and obvious variations thereof is contemplated as falling within the spirit and scope of the invention.

What is claimed is:

1. An apparatus for maintaining fishing equipment, the apparatus comprising:
a shell configured to receive an object attached to a fishing line; and
a gasket configured to surround the fishing line, the gasket creating a watertight seal between the fishing line and the shell, wherein the shell maintains a freshness of the object attached to the fishing line.

2. The apparatus of claim 1, wherein the shell comprises a first partial enclosure disposed opposite a second partial enclosure, wherein the first partial enclosure is matingly receivable with the second partial enclosure to define an object receiving space within the shell.

3. The apparatus of claim 2, wherein upon mating the first partial enclosure with the second partial enclosure, the shell comprises a watertight shell.

4. The apparatus of claim 2, further comprising a hinge coupling the first partial enclosure to the second partial enclosure, wherein the first partial enclosure and the second partial enclosure are pivotable about the hinge to reposition the first partial enclosure and the second partial enclosure from an opened positioned to a closed position, wherein the shell is watertight with the first partial enclosure and the second partial enclosure positioned in the closed position.

5. The apparatus of claim 2, wherein the first partial enclosure includes a first substantially hemispheric surface defining approximately one half a spherical void, wherein the second partial enclosure includes a second substantially hemispheric surface defining approximately one half a spherical void, wherein the first substantially hemispheric surface of the first partial enclosure and the second substantially hemispheric surface of the second partial enclosure define the object receiving space, wherein the object receiving space is substantially spherical upon mating the first partial enclosure with the second partial enclosure.

6. The apparatus of claim 1, further comprising a neck, wherein the gasket is positioned within the neck, the gasket forming a seal between the neck and the fishing line.

7. The apparatus of claim 1, wherein the shell includes an outer surface disposed opposite an inner surface, the inner surface defining an object receiving space within the shell, the outer surface of the shell having a bridging element extending from the outer surface, the bridging element defining a coupling element receiving slot.

8. The apparatus of claim 7, further comprising a coupling element positioned within the coupling element receiving slot, the coupling element configured to couple the apparatus to a fishing pole.

9. The apparatus of claim 8, wherein the coupling element comprising a twist-tie.

10. The apparatus of claim 1, wherein the shell includes an outer surface disposed opposite an inner surface, the inner surface defining an object receiving space within the shell, the outer surface of the shell having a hooking element extending from the outer surface of the shell, the hooking element configured to hook the apparatus to a fishing pole.
